(19) United States
(12) Patent Application Publication
(10) Pub. No.: US 2019/0021816 A1
(43) Pub. Date: Jan. 24, 2019

(54) ORTHODONTIC TREATMENT DEVICE

(71) Applicants: Marc Furtenhofer, Dortmund (DE); Volker Rummel, Dortmund (DE)

(72) Inventors: Marc Furtenhofer, Dortmund (DE); Volker Rummel, Dortmund (DE)

(21) Appl. No.: 15/757,453

(22) PCT Filed: Sep. 1, 2016
(86) PCT No.: PCT/EP2016/070613

§ 371 Date: Mar. 5, 2018

(30) Foreign Application Priority Data
Sep. 3, 2015 (DE) 10 2015 114 726.2

(51) Int. Cl. A61C 7/00; A61C 7/36

(52) U.S. Cl. CPC A61C 7/008; A61C 7/36

(57) ABSTRACT

An orthodontic treatment device having a U-shaped bite plate (2) which follows a jaw contour, a vibration unit (5) connected to the bite plate (2) to produce an oscillation of the bite plate, and a main unit (6) which is in contact with the vibration unit (5) and controls the same and provides it with power, wherein the vibration unit (5) and the main unit (6) are integrated liquid-tight in the bite plate, and a battery unit (7) of the main unit (6) is designed to charge wirelessly.

### BACKGROUND OF THE INVENTION

The invention relates to an orthodontic treatment device having a U-shaped bite plate which follows a jaw contour, a vibration unit connected to the bite plate to produce an oscillation of the bite plate, and a main unit which is in contact with the vibration unit and controls the same and provides it with power.

Orthodontic treatment devices of the aforementioned type, in particular orthodontic vibrating apparatus for accelerating orthodontic corrective measures, are known from the prior art. A so-called U-shaped bite plate that is positioned between the upper and lower dental arch is caused to vibrate overall or locally by vibration generators. According to the current results of science, the vibration can accelerate bone remodeling processes, and hence also tooth movement during an orthodontic treatment. It is possible to intentionally loosen the teeth to be regulated so that the treatment for correcting malpositions by means of, for example, braces can be more effective and quicker.

The known bite plates are generally connected to an extraoral main unit. With the older designs of these treatment devices, the main unit also contains the oscillation generator in addition to the power supply; accordingly, when the oscillation generator is activated, the vibration is transmitted to the overall bite plate, and hence to all the teeth as well. In improved variations, one or more oscillation generators are arranged on the bite plate. The oscillation generators are, however, also uncomfortably powered and actuated with a main unit to be worn extraorally.

### SUMMARY OF THE INVENTION

The object of the invention is therefore to provide a compact and individualized orthodontic treatment device that can be handled very comfortably and easily by the patient.

This object is achieved according to the invention by a device as disclosed herein. Advantageous embodiments of the invention are specified in the dependent claims.

The orthodontic treatment device has a U-shaped bite plate which follows a jaw contour, a vibration unit connected to the bite plate to produce an oscillation of the bite plate, and a main unit which is in contact with the vibration unit and controls the same and provides it with power. According to the invention, the vibration unit and the main unit are integrated liquid-tight in the bite plate, and a battery unit of the main unit is designed to charge wirelessly.

The liquid-tight integration of the vibration unit and the main unit in the bite plate that, in addition to the battery unit, can also have for example a control unit for regulating and adjusting the vibration, and/or a receiving unit for remote control, yields a highly compact and hence easy-to-use treatment device. At the same time, the wireless charging increases ease-of-use and, given the omission of contact points, ensures in a particularly reliable manner that penetrating moisture does not cause damage.

The bite plate of the treatment device according to the invention serves to transfer oscillations generated by the vibration unit to the teeth anchored in the jaw. In this regard, the design of the bite plate can be freely selected.

The bite plate can for example have a stable support on or in which the vibration unit and the main unit are arranged, and that is surrounded by a suitable material to ensure liquid-tightness. For this, the vibration unit and main unit, and possibly other functional components, can be embedded in a plastic and thus fixed in their position relative to each other. Alternatively, the vibration unit, the main unit, and possibly other functional components can be arranged on a fixed support plate. The vibration unit, main unit and possibly other functional components can be connected to the support plate as desired. An integral connection by adhesion, soldering or welding is accordingly possible depending on the material. Moreover, a keyed connection, for example in the form of clicking, latching and/or bayonet connecting elements can be provided. If the support plate is designed with recesses for accommodating the vibration unit, the main unit and possibly other functional components, a friction connection is also conceivable by suitably dimensioning the recesses with regard to the size of the vibration unit(s), main unit and possibly other functional components to be accommodated, or by inserting adapting inserts.

The plastic support with the embedded functional components or the support plate with the functional components arranged thereupon are surrounded liquid-tight with a suitable material such as silicone or another biocompatible material.

The bite plate can then have different materials or material combinations depending on the production method. If no intolerance exists on the part of the patient, it is preferably formed from any desired biocompatible and medically permissible polymers or combinations. This includes also silicones in addition to carbon-based polymers. Preferably, thermoplastics such as polymethyl methacrylate (PMMA) or polyethylene terephthalate (PETG) are used.

These are plastics that soften at temperatures above 100° C. and can easily be transformed into the desired shape. In a soft state, the flow behavior of the material moreover enables the liquid-tight embedding, or respectively encapsulation of functional components according to the invention such as the vibration unit and the main unit. Moreover, the thermoplastic behavior also permits subsequent corrections or repairs to the bite plate.

Alternatively, the shaping of the bite plate and liquid-tight embedding or encapsulation of the functional components can also occur during the polymerization process of the polymer. At the same time, the elasticity or hardness of the polymer can be influenced by adding additives, whereby the bite plate can be designed with regions of different hardness. This for example makes it possible to specifically influence wearing comfort, fit, shape and bite stability locally. Afterward as well, the bite plate can be individualized/adapted by grafting on polymer material.

The type of generated vibrations is also varied. Accordingly, depending on the required type of treatment, the vibrations can for example be oscillating, random or polarized as well. Consequently, to accelerate tooth movement in the context of the measures for correcting the tooth malpositions, possibly to increase individual compliance, different types of pulses are used, wherein the pulse types differ in frequency, interval (duration and/or the frequency) and/or strength. In particular in the multi-band/multi-bracket treatment explained further below, a specific sequence of pulses is also provided to optimize the reduction of friction.

In addition to use along with and preferably accelerating teeth adjustment, the treatment device according to the invention can generally be used to accelerate bone remodeling processes in the jaw region, as well as to loosen friction in multi-band/bracket treatments, or for osteopathic treatment of sutural stress in the facial skull, and/or physiotherapeutic treatment of muscular stress in the masticatory muscles. Since teeth clenching and/or grinding is frequently the trigger for such stress, treatment of the stress can be undertaken using the treatment device according to the invention, and/or the tooth damage resulting from bruxism can be simultaneously prevented. By suitably selecting the vibration frequency, the treatment device according to the invention can also be provided after trauma to stimulate optimum cell growth and faster healing of tissue associated therewith.

According to the invention, the main unit has a battery unit, which is designed for wireless charging, supplying the main unit and the vibration unit with energy. It is therefore possible to wirelessly charge the battery unit of the treatment device according to the invention even while it is being used by means of an extraoral energy transmission unit. Preferably, the treatment device according to the invention is charged wirelessly by means of a charging station during its resting time outside of the mouth, i.e., without electrical contact.

In this regard, charging can be carried out by any form of wireless energy transmission. This includes for example inductive coupling by a magnetic flux, or capacitive coupling by an electrical field. Charging by electromagnetic waves is however also conceivable.

The orthodontic treatment device according to the invention can be used in combination with or as a supplement to any measures for correcting tooth malpositions. Hence, the treatment device according to the invention can always be used briefly before wearing a conventional loose brace. An improved effect is, however, realized by the interaction between the so-called multi-band/multi-bracket method and the orthodontic treatment device according to the invention. Whereas a loose, i.e., removable, brace extends partially over the masticatory surfaces of the teeth proceeding from the gums and accordingly prevents the treatment device according to the invention from being simultaneously worn, tooth malposition is corrected in the multiband/multi-bracket treatment by the stress from wires that are connected to the teeth by brackets attached securely to the outer labial and/or buccal, and/or inner lingual, and/or palatal tooth surfaces. The occlusal masticatory surfaces therefore remain substantially free. Since the treatment device according to the invention can be designed very compactly and small, it can also be used parallel to the fixed multiband/multi-bracket brace. Accordingly, an orthodontic force and the vibration can therefore be transmitted simultaneously to the tooth/teeth which results in even faster tooth movement.

The orthodontic treatment device according to the invention can be adapted individually to the patient's bite. Independent of the production method, for example with standard impression trays, a negative impression of the patient's bite can be taken and cast with plaster. The treatment device according to the invention can be produced based on this dental model. In this regard, either the ready-to-use thermoplastic material can be softened by heating and adapted to the plaster model, wherein the functional components are incorporated into the material at appropriate locations. For this, a heated, multilayer plastic film can be laminated into the functional components, for example, and drawn to the dental model with a vacuum forming unit. Alternatively, a type of casting mold can be produced using the model in which the treatment device according to the invention is produced similar to injection molding. If the monomers or respectively pre-polymers are used instead of a softened ready-to-use thermoplastic, all polymerization and curing of the treatment device can occur in such a casting mold produced based on the dental model.

In a preferred embodiment of the treatment device according to the invention, the bite plate is formed with individual anterior and/or lateral bite impressions. More preferably, the bite plate has projections adjacent to a surface provided for placement on the incisal and occlusal tooth surfaces, and/or subsurface for placement on labial, buccal, lingual and/or palatal tooth surfaces similar to a mouth guard known from boxing.

This further embodiment of the invention ensures in a particularly reliable manner a secure positioning of the treatment device within the oral cavity at its intended position. Moreover, the additional contact surfaces ensure a particularly effective transmission of the generated vibrations to the teeth.

More preferably, the baseplate has projections, recesses and/or elevations. The recesses and/or elevations are preferably adapted to the tooth shape and enable a further improved retention of the bite plate as well as improved oscillation transmission. Small elevations and/or tabs are for example conceivable that are possibly also formed before the projections in order to provide the incisors with effective retention for the bite plate. The recesses and/or elevations can however also be formed in the event of anatomical anomalies to enable an improved seat. They are then designed to be more pronounced and enable a reliable contact, including with teeth that are arranged offset.

In principle, the surfaces of the bite plate can be designed with bite impressions, projections, recesses, elevations etc. in any desired manner, for example directly when molding the bite plate using a plastic. Alternatively, it is possible to form the surfaces, as well as bite impressions, projections, recesses, elevations, etc. on a casing of the bite plate, for example a silicone jacket, which allows standardized bite plates to be easily individualized.

When forming the aforementioned structures in the silicone jacket, it is possible to take into account the individual bite parameters in producing the bite plate, or afterwards as well. Accordingly, the bite plate can also be adapted over the course of treatment to any changes in the teeth.

In the context of a standardized production method, a further embodiment of the invention provides forming the bite plate of the treatment device to be adapted to anatomical peculiarities arising from anomalies. Accordingly, for example to take into account an open bite in which a gap remains between teeth of the maxilla and mandible when the dental arches are closed, the bite plate can be designed to be thicker to fill in corresponding regions. With an anterior open bite, the bite plate can also be designed to be thicker in the anterior region, generally in the region of the incisors and possibly the canines as well. With a laterally open bite, the bite plate can be designed to be thicker in the lateral region, i.e. in the region of the cheeks and possibly the canines.

Moreover if it is deemed necessary, it is possible to take into account anatomical peculiarities from anomalies by means of an individualized production in addition to production according to a standardized method. Consequently, unusual anomalies such as shifted canines can be considered by projecting bite plate sections, wherein vibration elements can also be integrated into these elevations as well.

In this regard, the vibration unit can have a single, central vibration element, as well as possess two or more vibration elements that can be coupled to each other or are individually actuatable by the main unit.

According to a further embodiment of the invention, it is provided that the vibration unit extends substantially over the entire bite plate, wherein however the liquid-tight integration of the vibration unit and main unit in the bite plate is simultaneously ensured. In this regard, the location and/or the position of the main unit as well as the vibration unit can be individually adapted to the individual anatomical conditions. This ensures that the oscillations are transmitted to the entire bite plate, in particular, however to the teeth and/or tooth sections to be treated.

According to a preferred embodiment of the invention, it is provided that the vibration unit has at least one, preferably a plurality of vibration elements arranged at a distance from each other. Hence, preferably when there is a plurality of vibration elements, an even oscillation of the bite plate can be achieved. For this, the vibration elements can be evenly spaced. It is however also conceivable for the vibration elements to be arranged so that different regions of the bite plate oscillate to a varying extent. It is also possible for the plurality of vibration elements to oscillate at different times and/or at a different level or frequency.

More preferably, at least one vibration element is arranged adjacent to the surface and/or the subsurface, and/or at least sectionally within the projections and/or elevations. With this arrangement, a highly effective oscillation transmission can be achieved, in particular also taking into account the individual requirements.

According to a further embodiment of the invention, it is provided that the top surface of the bite plate facing the bite surface or respectively masticatory surface of the top side of the tooth, and/or the bottom side of the bite plate facing the bite surface or respectively masticatory surface of the bottom side of the tooth has bumps projecting therefrom. These autoadaptive bumps insure an individual adaptation of the bite plate to the bite. Preferably, the bumps also enable ongoing use of the treatment device according to the invention in various stages of treatment without renewed adaptation. At the same time, the bumps achieve a greater contact surface between the tooth and the treatment device. This yields improved transmission of the vibration to the teeth and hence preferably a significant increase in efficiency.

The bumps can be designed in any desired shape. Accordingly, bumps with a round or also cornered cross-section are conceivable. The length of the bumps can also be variably selected. Preferably, the bumps have a length of 0.5 mm to 5 mm, more preferably 1 mm to 3 mm. The diameter of the bumps is preferably within a range of 0.25 to 3 mm. The surface of the bumps can be smooth or structured. The free end of each bump can be designed rounded, flat or fibrous in the form of a paintbrush.

According to a preferred embodiment of the invention, the main unit has control means for activating and/or establishing the type, duration, frequency and/or intensity of the oscillation generated by the vibration unit, or respectively the vibration elements.

The control means can be operated by means of a pushbutton on the treatment device, or remote controllable inductive sensors. Preferably however, the control means have a receiving unit that is designed to communicate with an external transmitter.

A receiving unit enables control with a separate remote control. In a corresponding design, the control with a smart phone app is also conceivable. Additional data such as for example the charge status and duration of use can also be detected by the receiving unit. Moreover, treatment profiles can be programmed that are individually tailored to the patient with, if applicable, specific types of pulses relating to the type, duration, frequency and/or intensity of the vibrations and/or pulse pattern, which can also comprise pulse intervals with identical or different types of pulses in addition to the impulse type. Faulty operation is thus avoided.

In this regard, the main unit has a corresponding design, for example a memory chip, preferably a remote memory chip, such as a WLAN memory chip, and/or a microprocessor. Operation is carried out by the battery unit.

The main unit as well as the vibration motors and/or if applicable other functional components can also be arranged in a projection or recess of the treatment device according to the invention. A grip can be coupled to this projection or in this recess that makes removal and insertion more comfortable. The projection in this regard can also be designed so that it forms the grip by itself.

According to a preferred embodiment of the invention, the main unit is however integrated in the bite plate so that the surfaces of the bite plate facing the gums and the tongue, and/or the surfaces of the bite plate facing the lips, or respectively the cheeks are designed flat, at least in a region of the main unit, and substantially without projections or recesses. According to this development of the invention, the surfaces have an even U-shaped contour with a continuous curvature from which no components project toward the lips, or respectively the gums. The main unit and its components are preferably integrated in the casing so that they do not, or scarcely perceptibly, project from the surfaces of the bite plate facing the gums and tongue, and/or the surfaces of the bite plate facing the lips, or respectively the cheeks. This embodiment leads to pleasant wearing comfort. Moreover, a flat and smooth casing offers less exposure potential for friction wear.

The vibration unit can comprise any desired means for generating vibration. Accordingly, the vibration elements can be formed by electromagnetic motors or piezoelements. Mechanical actuators are however also conceivable such as imbalance motors. Preferably, mini- or micro-vibration motors, and more preferably so-called coin or disk vibration motors or ultrasonic generators are used. This type of vibration element is particularly small and accordingly only requires a slight amount of installation space. Accordingly, these can also be easily embedded entirely or at least partially in the projections and/or elevations of the orthodontic treatment device.

In principle, the frequency of the oscillations generated by the vibration elements are selectable as desired within the frequency range needed for the respective treatment. According to a preferred embodiment of the invention, the teeth are supplied with vibrations by the vibration elements, or respectively the vibration unit within a frequency range between 0 Hz and 1000 Hz, preferably between 0 Hz and 300 Hz, and more preferably between 0 Hz and 100 Hz. The force exerted on the teeth by the oscillations lies within a range of 0.1-10 N. Depending on the required treatment, operation within the ultrasonic range is also conceivable.

According to a further embodiment of the invention, it is provided that the orthodontic treatment device according to the invention is designed to be self-cleaning. For this, the orthodontic treatment device has a self-cleaning mode. This self-cleaning mode can be activated by the control means, wherein the vibration unit of the treatment device then generates a specific oscillation that is suitable for cleaning the device. For cleaning, the treatment device can be exposed to cleaning and/or disinfecting oscillation (such as ultrasound) by the vibration unit connected to the bite plate during extraoral storage in a container filled with a cleaning solution. In a corresponding arrangement of the charging station and cleaning/storage container, cleaning can occur at the same time as the charging process.

### BRIEF DESCRIPTION OF THE DRAWINGS

Exemplary embodiments of the invention will be described below with reference to the drawings. In the drawings:

FIG. 1 shows a sketched representation of a perspective view of a first embodiment of an orthodontic treatment device;

FIG. 2 shows a sketched representation of a plan view of a second embodiment of an orthodontic treatment device;

FIG. 3 shows a sketched representation of a view of a section along section line A-A from FIG. 2;

FIG. 4 shows a sketched representation of a view of a section along section line B-B from FIG. 2;

FIG. 5 shows a sketched representation of a side view of the treatment device from FIG. 2;

FIG. 6 shows a sketched representation of a plan view of a third embodiment of the treatment device;

FIG. 7 shows a sketched representation of a side view of the treatment device from FIG. 6;

FIG. 8 shows a sketched representation of a plan view of a support plate of a fourth embodiment of the treatment device;

FIG. 9 shows a sketched representation of a view of a section along section line C-C from FIG. 8;

FIG. 10 shows a sketched representation of a sectional view of a fifth embodiment of the treatment device;

FIG. 11 shows a sketched representation of the treatment device from FIG. 10 with a closed bite;

FIG. 12 shows a sketched representation of the treatment device from FIG. 10 in a side view with a closed bite;

FIG. 13 shows a sketched representation of a sectional view of a sixth embodiment of the treatment device.

### DETAILED DESCRIPTION

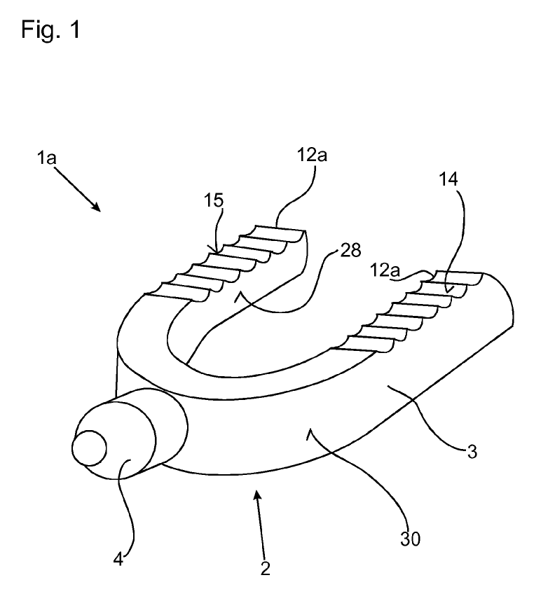

FIG. 1 shows an embodiment of an orthodontic treatment device 1a. It has a U-shaped bite plate 2 with a liquid-tight casing 3. The orthodontic treatment device 1a is designed with a projection 4 in which a main unit 6 (not shown here) is arranged with a wirelessly chargeable battery unit 7 (also not shown here). The projection 4 can also be used as a tool for easier removal or insertion, or as an adapter for a corresponding grip. In the region of the occlusal masticatory surfaces 12a, the bite plate 2 is provided with recesses 14 and elevations 15 that effectively prevent slippage in interaction with the teeth to be treated.

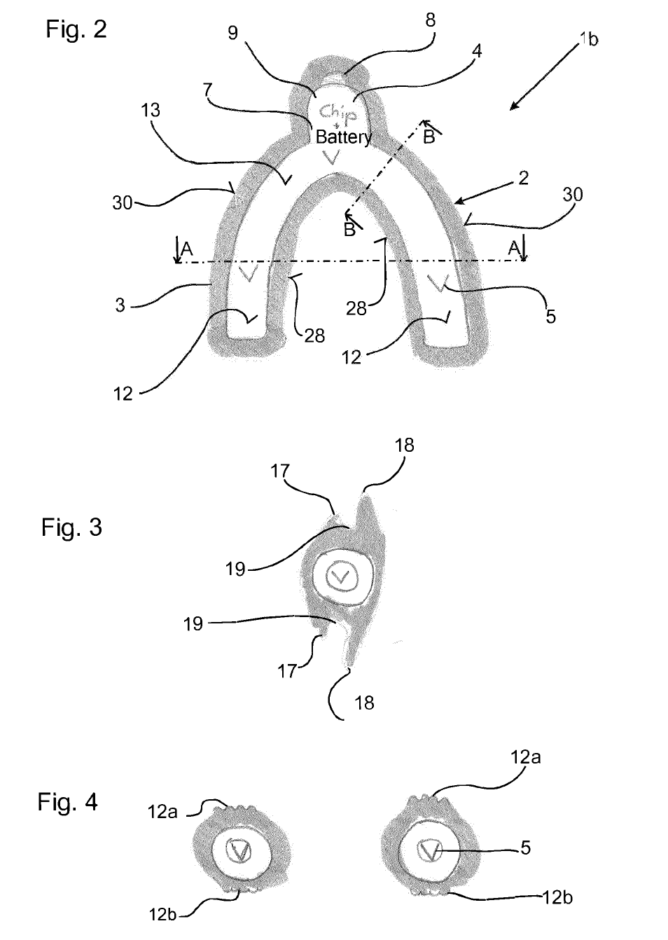

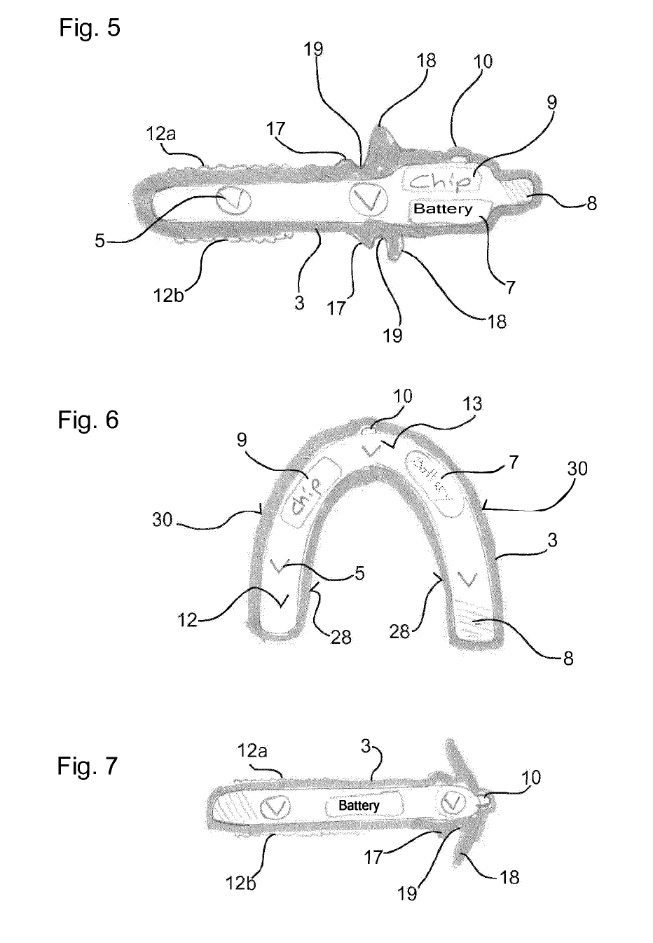

A second embodiment of a treatment device 1b is shown in FIG. 2 to FIG. 5 with a bite plate 2 covered liquid-tight with a silicone layer 3. To accommodate the main unit 6 with a battery 7 and a control means designed as a chip 9, the bite plate 2 is designed with a projection 4 in the labial, anterior region, at the free end of which an induction charge coil 8 is arranged for wirelessly charging the battery 7. Moreover in the region of the anterior masticatory surfaces 13a, 13b and the lateral masticatory surfaces 12a, 12b of the bite plate, vibration units 5 are arranged that together form a vibration unit of the treatment device 1a to 1d. In this regard, the vibration elements 5 are embedded in the basic material of the bite plate 2 surrounded with a casing 3 of silicone.

Moreover, the casing 3 has a bite groove 19 adapted individually to the bite with projections 17, 18 provided for contacting labial, lingual and/or palatal tooth surfaces. For contacting the buccal tooth surfaces, shield-shaped projections (not shown here) can also be provided analogous to the anterior shields.

FIG. 6 to FIG. 7 show a third embodiment of the treatment device 1c. This is a slim embodiment version that is distinguished by a particularly pleasant wearing comfort. The main unit 6, or respectively the individual components of the main unit 6, are arranged on the bite plate 2 so that they do not, or scarcely perceptibly, project from the surfaces of the bite plate 2 facing the gums and tongue, and/or the surfaces of the bite plate 2 facing the lips, or respectively the cheeks. Accordingly, the battery 7, the charge coil 8, and the chip 9 are embedded in the basic material of the bite plate 2 like the vibration generators 5. Only the on/off switch 10 projects slightly from the surface of the bite plate facing the lips for safe and optimum operation. By dispensing with the on/off switch 10, the projection 10a associated therewith can also be eliminated when there is remote-controlled activation of an embodiment of the orthodontic treatment device 1c (not shown here) by the control means 9.

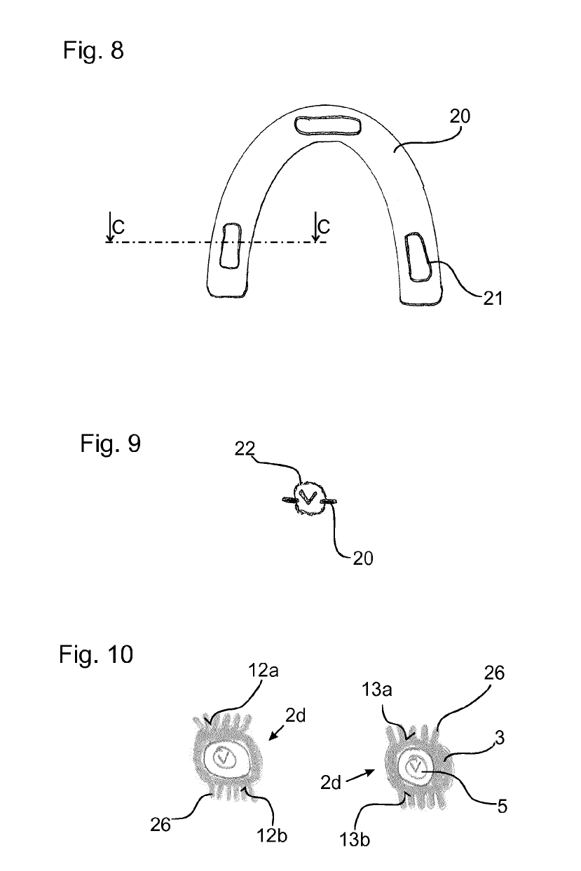

In the fourth embodiment shown in FIG. 8 and FIG. 9 of the orthodontic treatment device 1d, the vibration elements 5 are not embedded in a basic matrix. Contrastingly, a support plate 20 is provided with recesses 21 in which the vibration units 5 are inserted such that they project from the support plate 20 on one or both sides. To protect the vibration units 5, they are provided with protective caps 22 after being arranged in the recesses 21 of the support plate 20.

The vibration elements 5 are integrally bonded with the support plate 20. In embodiments of the orthodontic treatment device 1d (not shown), for example clicking and latching connecting elements are used for a keyed connection, or a friction connection is realized by suitably dimensioning the sizes of the vibration element, recesses 21 and possibly protective caps 22, or respectively the encapsulated vibration elements. Other embodiments (not shown) of the orthodontic treatment device 1d use combinations of the aforementioned types of connection.

After arrangement of the vibration elements 5, the main unit 6 and if applicable the on/off switch 10 and/or a charge coil 8, the equipped support plate 20 with all of the components is covered liquid-tight with a silicone layer 3.

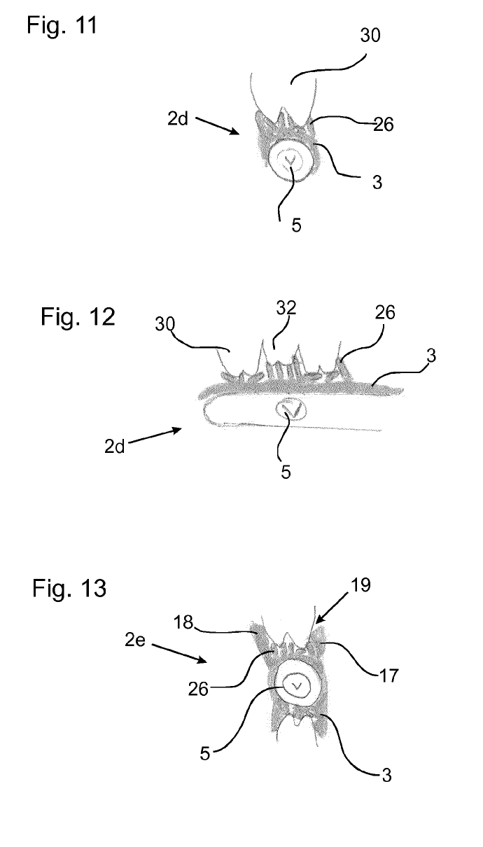

In a fifth embodiment shown in FIG. 10 to FIG. 12, the casing 3 of the bite plate 2 is formed on its surfaces 12a, 12b, 13a, 13b that face the masticatory surfaces with bumps 26. Given the elasticity of the bumps 26, they are aligned by the tooth crowns 30 in a closed bite so that they ensure optimum contact with the tooth surface in all sections of the tooth crowns 30, even when the tooth crowns 32 are comparatively short or penetrate through. An effective transmission of oscillation is thereby achieved, as well as an effective retention of the treatment device.

In a sixth embodiment of the treatment device (FIG. 13), the casing 3 has a bite groove 19 that is individually adapted to the bite. In the region of the bite groove 19, the casing 3 of the bite plate 2 is designed with bumps 26 that precisely lie against all of the regions of the relief-like tooth crown surfaces in a closed bite. The projections 17, 18 provided for contacting labial, lingual and/or palatal tooth surfaces secure the treatment device 1e against undesirable slippage in the given position, and also transfer the oscillations in a targeted manner to the labial, lingual, and/or palatal tooth surfaces.

1. An orthodontic treatment device having:
a U-shaped bite plate (2) which follows a jaw contour,
a vibration unit (5) connected to the bite plate (2) to produce an oscillation of the bite plate, and
a main unit (6) which is in contact with the vibration unit (5) and controls the same and provides it with power,
wherein
the vibration unit (5) and the main unit (6) are integrated liquid-tight in the bite plate, and a battery unit (7) of the main unit (6) is designed to charge wirelessly.

2. The orthodontic treatment device according to claim 1, wherein the bite plate (2) has projections (15, 17, 18) adjacent to a surface (12a, 13a) provided for placement on the incisal and occlusal tooth surfaces, and/or subsurface (12b, 13b) for placement on labial, buccal, lingual and/or palatal tooth surfaces.

3. The orthodontic treatment device according to claim 1, wherein the vibration unit (5) extends substantially over the entire bite plate (2).

4. The orthodontic treatment device according to claim 1, wherein the bite plate (2) has projections (4), recesses (14, 19) and/or elevations (15, 17, 18).

5. The orthodontic treatment device according to claim 1, wherein the vibration unit has a plurality of vibration elements (5) arranged at a distance from each other.

6. The orthodontic treatment device according to claim 1, wherein the vibration unit (5) is arranged adjacent to the surface and/or the subsurface, and/or at least sectionally within the projections (4) and/or elevations (15, 17, 18) of the bite plate (2).

7. The orthodontic treatment device according to claim 1, wherein the surface and/or subsurface of the bite plate (2) has bumps (26) projecting therefrom.

8. The orthodontic treatment device according to claim 1, wherein the main unit (6) has control means (9) for establishing the duration, type, and/or intensity of the oscillation.

9. The orthodontic treatment device according to claim 8, wherein the control means (9) have a receiving unit that is designed to communicate with an external transmitter.

10. The orthodontic treatment device according to claim 1, wherein the main unit is integrated in the bite plate so that the surfaces (28) of the bite plate (2) facing the gums and the tongue, and/or the surfaces (30) of the bite plate (2) facing the lips, or respectively the cheeks are designed flat, at least in the region of the main unit (6), and substantially without projections or recesses.

11. The orthodontic treatment device according to claim 1, wherein the vibration unit generates oscillation at a frequency less than or equal to 1000 Hz, preferably less than or equal to 300 Hz.

12. The orthodontic treatment device according to claim 5, wherein the vibration elements (5) are formed by vibration motors and/or ultrasonic generators.

13. The orthodontic treatment device according to claim 11, wherein the frequency is less than or equal to 300 Hz.

14. The orthodontic treatment device according to claim 11, wherein the frequency is less than or equal to 100 Hz.
